(19) United States
(12) Patent Application Publication
(10) Pub. No.: US 2018/0009086 A1
(43) Pub. Date: Jan. 11, 2018

(54) SELF-LOCKING PLIERS

(71) Applicant: Gong Maw Enterprise Co., Ltd., TAICHUNG CITY (TW)

(72) Inventor: Ming Chieh Wu, TAICHUNG CITY (TW)

(21) Appl. No.: 15/203,861

(22) Filed: Jul. 7, 2016

(51) Int. Cl. B25B 7/12; B25B 7/14; B25B 7/10

(52) U.S. Cl. CPC B25B 7/12; B25B 7/10; B25B 7/14

(57) ABSTRACT

A pair of self-locking pliers includes three body structures pivotally connected. Each of the three body structure has a slot, and a shaft engages in the slots. The slots cooperate to surround a space and the shaft is constrained in the space. Two of the three body structures include two jaws and are pivotal relative to each other between a first position in which the two jaws are disposed adjacent to each other, and a second position in which the two jaws are disposed apart from each other. The first, second, and third slots are adapted to releasably restrain the shaft, thereby preventing the first, second, and third body structures from pivoting relative to each other.

### BACKGROUND OF THE INVENTION

### 1. Field of the Invention

The present invention relates to locking pliers and, particularly, to self-locking pliers that will lock an object held therein.

### 2. Description of the Related Art

TW Pat. No. M448347 shows a pair of locking pliers including a first handle, a first jaw fixedly disposed on the first handle, a second handle, and a second jaw movable disposed on the second handle. The second jaw is pivotally connected to the second handle. The second jaw is also pivotally connected to the first handle. A pivot interconnects the second jaw and the first handle and is inserted through a first hole defined by the second jaw and a second hole defined by the first handle. The second hole has a greater diameter than the pivot such that the pivot is not only pivotal but also movable in the second hole. A connecting member includes one end pivotally connected to the first handle and another end pivotally connected to the second handle. A spring couples the first handle and the second jaw.

The second handle is movable towards the first handle. By moving the second handle towards the first handle, the second jaw moves towards the first jaw and, in addition, the pivot moves in the second hole. The second handle is movable to a locking position in which the second jaw is positioned fixedly with respect to the first jaw. Therefore, an object can be locked between the first and second jaws.

In view of the foregoing, the pair of the self-locking pliers has a complex structure. Thus, assembly of the pair of self-locking pliers takes effort. In addition, it is desirable to cut manufacture costs.

The present invention is, therefore, intended to obviate or at least alleviate the problems encountered in the prior art.

### SUMMARY OF THE INVENTION

According to the present invention, a pair of self-locking pliers includes a first body structure, a second body structure, a third body structure, and a pivot pivotally connecting the first, second, and third body structures at such that the first, second, and third body structures are pivotal relative to each other and about the pivot;

The first body structure has a first pivot connection and a first slot. The first slot extends in depth through the first body structure. The first slot extends in length in a straight line and forms two opposite straight lateral sides.

The second body structure has a second pivot connection and a second slot. The second slot extends in depth through the second body structure. The second slot extends in length in a straight line and forms two opposite straight lateral sides.

The third body structure has a third pivot connection and a third slot. The third slot extends in depth through the third body structure. The third slot extends in length in a straight line and forms two opposite straight lateral sides.

The pivot pivotally connecting the first, second, and third body structures at the first, second, and third pivot connections.

Further, a shaft connects the first, second, and third body structures and is movably disposed in the first, second, and third slots. The two lateral sides of the first, second, and third slots cooperate to surround a space and the shaft is constrained in the space.

Two of the first, second, and third body structures include two jaws and are pivotal relative to each other between a first position in which the two jaws are disposed adjacent to each other, and a second position in which the two jaws are disposed apart from each other and; and

The space is formed at a location in proximity to first distal ends of the first, second, and third slots and constrains the shaft when the two jaws are disposed adjacent to each other; and

The space is formed at a location in proximity to second distal ends of the first, second, and third slots and constrains the shaft when the two jaws are disposed apart from each other; and

The shaft moves towards the first distal ends of the first, second, and third slots when the two of first, second, and third body structures pivot relative to each other from the second position to the first position.

The shaft moves towards the second distal ends of the first, second, and third slots when the two of first, second, and third body structures pivot relative to each other from the first position to the second position.

The first, second, and third slots are adapted to releasably restrain the shaft, thereby preventing the first, second, and third body structures from pivoting relative to each other.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the public generally, and especially the scientists, engineers and practitioners in the art who are not familiar with patent or legal terms or phraseology, to determine quickly from a cursory inspection the nature and essence of the technical disclosure. The abstract is neither intended to define the invention, which is measured by the claims, nor is it intended to be limiting as to the scope of the invention in any way.

It is therefore an objective of the present invention to provide a pair of self-locking pliers.

It is another objective of the present invention that resolves the set forth issues.

Other objectives, advantages, and new features of the present invention will become apparent from the following detailed description of the invention when considered in conjunction with the accompanied drawings.

### BRIEF DESCRIPTION OF THE DRAWINGS

FIG. 1 is a perspective view of a pair of self-locking pliers in accordance with the present invention.

FIG. 2 is an exploded perspective view of the pair of locking pliers of the present invention.

FIG. 3 is side view showing the pair of the self-locking pliers of the present invention in a locking position.

FIG. 4 is a cross sectional view taken along line 4-4 of FIG. 3.

FIG. 5 is a partial, enlarged view of FIG. 3.

FIG. 6 is a partial, side view showing the pair of self-locking pliers of the present invention in a fully open position.

### DETAILED DESCRIPTION OF THE INVENTION

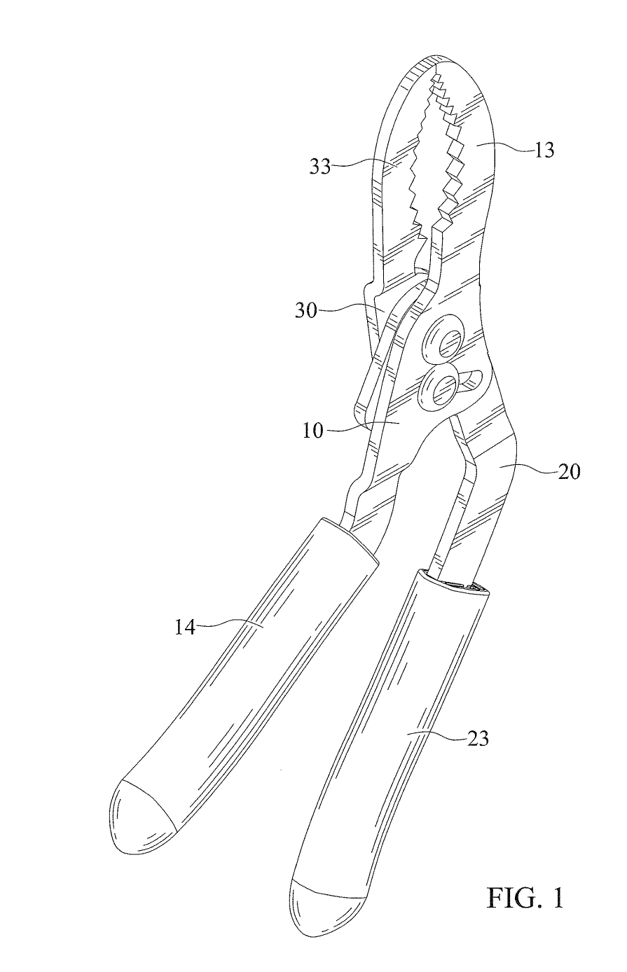

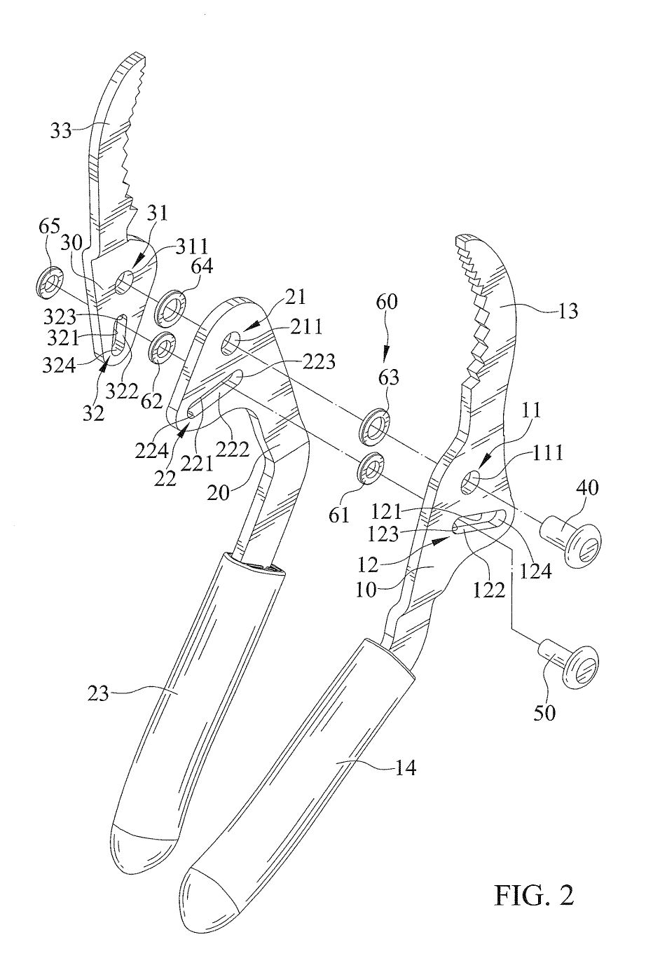

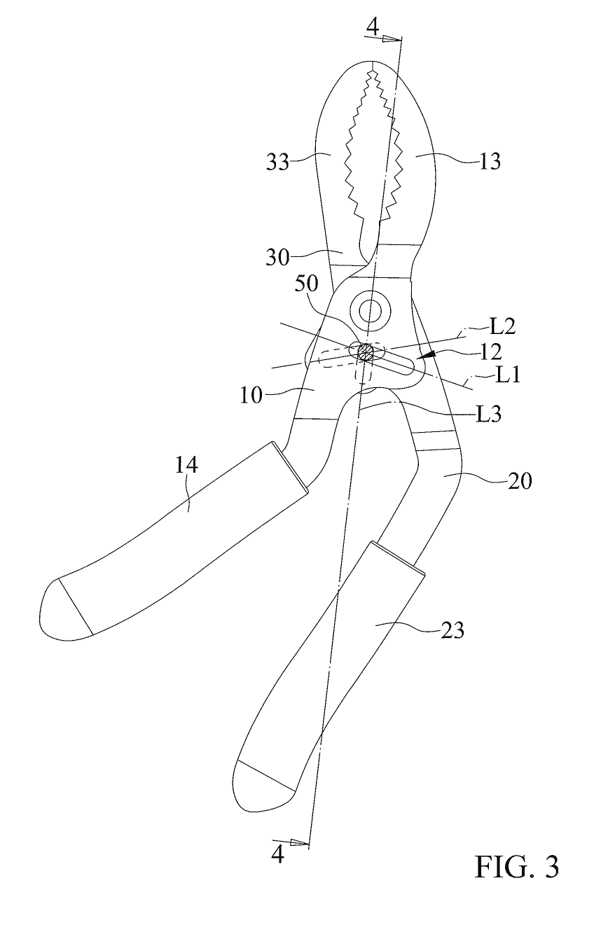

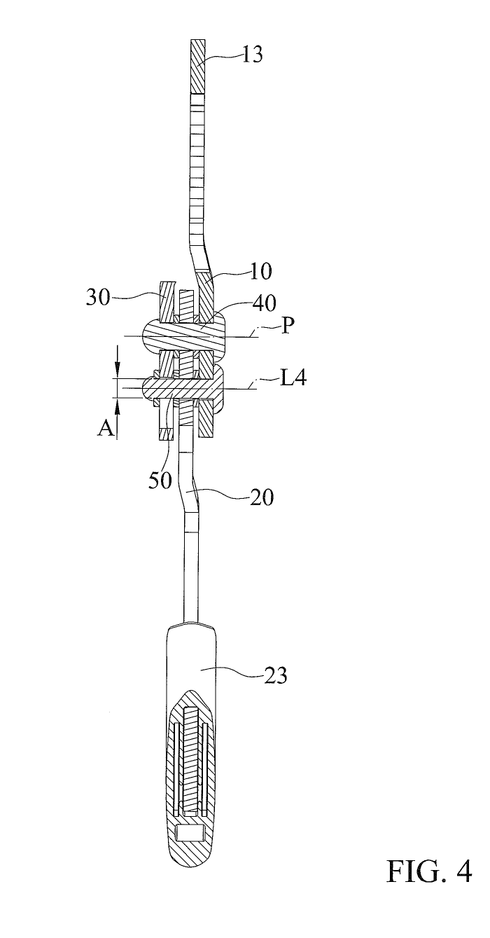

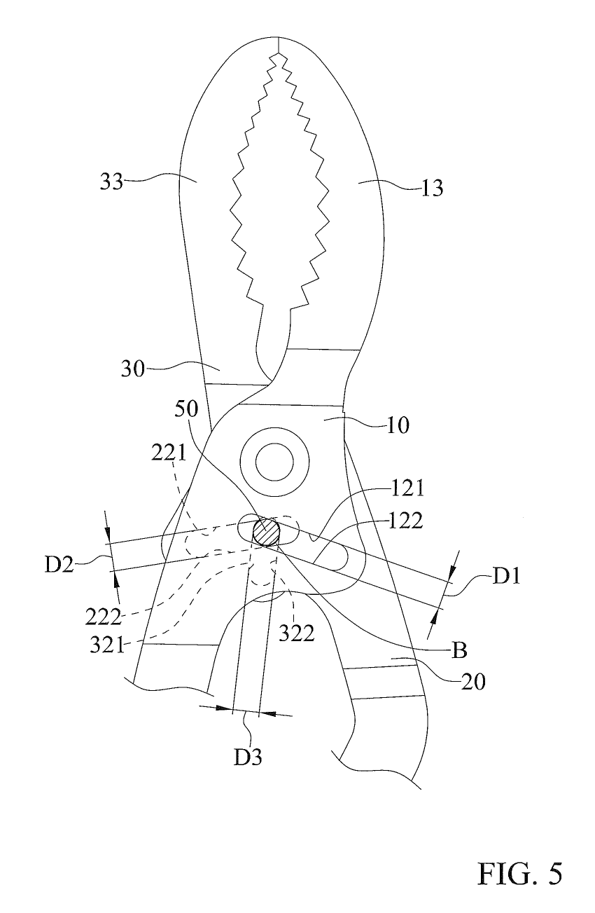

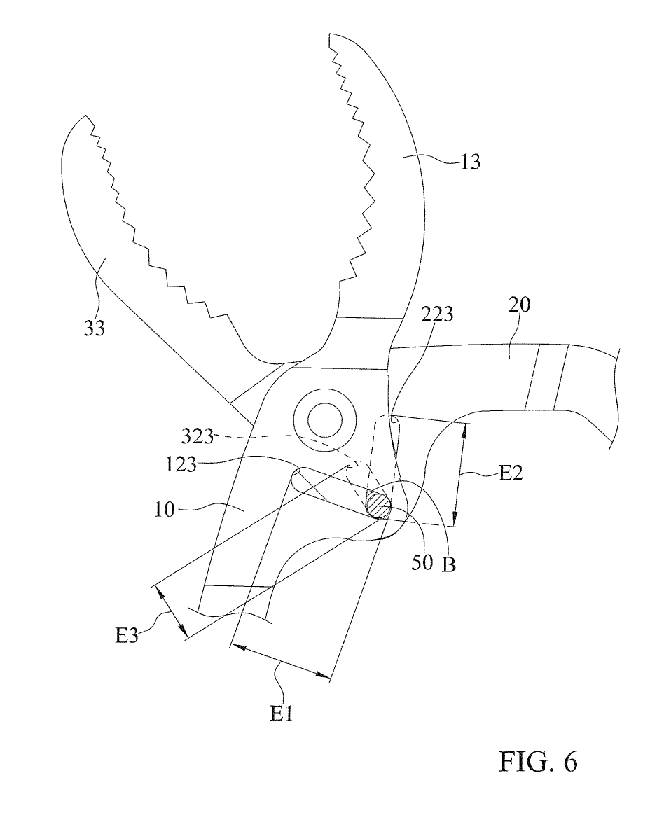

FIGS. 1 through 6 show a pair of self-locking pliers in accordance with the present invention.

A first body structure 10 has a first pivot connection 11 and a first slot 12. The first slot 12 extends in depth through the first body structure 10. The first slot 12 extends in length in a straight line and forming two opposite straight lateral sides 121 and 122. The first slot 12 extends in length along a first axis L1.

A second body structure 20 has a second pivot connection 21 and a second slot 22. The second slot 22 extends in depth through the second body structure 20. The second slot 22 extends in length in a straight line and forming two opposite straight lateral sides 221 and 222. The second slot 22 extends in length along a second axis L2.

A third body structure 30 has a third pivot connection 31 and a third slot 32. The third slot 32 extends in depth through the third body structure 30. The third slot 32 extends in length in a straight line and forming two opposite straight lateral sides 321 and 322. The third slot 32 extends in length along a third axis L3.

A pivot 40 pivotally connects the first, second, and third body structures 10, 20, and 30 at the first, second, and third pivot connections 11, 21, and 31 such that the first, second, and third body structures 10, 20, and 30 are pivotal relative to each other and about the pivot 40. The pivot 40 defines a pivot axis P. Because the first, second, and third body structures 10, 20, and 30 are pivotal relative to each other and about the pivot 40, the first, second, and third body structures 10, 20, and 30 are pivotal about the pivot axis P.

A shaft 50 connects the first, second, and third body structures 10, 20, and 30 and is movably disposed in the first, second, and third slots 12, 22, and 32. The two lateral sides of the first, second, and third slots 12, 22, and 32 cooperate to surround a space and the shaft 50 is constrained in the space.

Two of the first, second, and third body structures 10, 20, and 30 include two jaws 13 and 33 and are pivotal relative to each other between a first position in which the two jaws 13 and 33 are disposed adjacent to each other, and a second position in which the two jaws 13 and 33 are disposed apart from each other. The space is formed at a location in proximity to first distal ends 123, 223, and 323 of the first, second, and third slots 12, 22, and 32 and constrains the shaft 50 when the two jaws 13 and 33 are disposed adjacent to each other. The space is formed at a location in proximity to second distal ends 124, 224, and 324 of the first, second, and third slots 12, 22, and 32 and constrains the shaft 50 when the two jaws 13 and 33 are disposed apart from each other.

The two of the first, second, and third body structures 10, 20, and 30 include two handles. One of the two jaws 13 and 33 and one of the two handles are located at opposite ends of one of the two of the first, second, and third body structures 10, 20, and 30. Another of the two jaws 13 and 33 and another of the two handles are located at opposite ends of another of the two of the first, second, and third body structures 10, 20, and 30. Two handle covers 14 and 23 are sleeved on the two handles which are configured to allow a user to grip the two handles comfortably.

The shaft 50 has a circular cross section. The shaft 50 is of a diametrical size A. Each of the first, second, and third slots 12, 22, and 32 is of a width larger than the diametrical size A. The width of the first slot 12 corresponds to a distance D1 between the two lateral sides 121 and 122. The width of the second slot 22 corresponds to a distance D2 between the two lateral sides 221 and 222. The width of the third slot 33 corresponds to a distance D3 between the two lateral sides 321 and 322. Each of the first, second, third slots 12, 22, and 32 includes the width 1.001-1.2 times the diametrical size of the shaft 50. Each of the first, second, and third slots 12, 22, and 32 has a length E1, E2, and E3. Two of the first, second, and third slots 12, 22, and 32 are of the same length substantially and another of the first, second, and third slots 12, 22, and 32 is of a length shorter than those of the two of the first, second, and third slots 12, 22, and 32. The lengths of two longer slots of the first, second, and third slots 12, 22, and 32 are factors determining relative positions of the jaws 13 and 33.

The first, second, and third axes L1, L2, and L3 intersect at a location in proximity to the first distal ends 123, 223, and 323 of the first, second, and third slots 12, 22, and 32 when the two jaws 13 and 33 are disposed adjacent to each other. The first, second, and third axes L1, L2, and L3 intersect at a location in proximity to the second distal ends 124, 224, and 324 of the first, second, and third slots 12, 22, and 32 when the two jaws 13 and 33 are disposed apart from each other. Two of the first, second, and third slots 12, 22, and 32 form a v-shaped configuration when the two jaws 13 and 33 are disposed adjacent to each other, and form an inverted v-shaped configuration when the two jaws 13 and 23 are disposed apart from each other.

The shaft 50 moves towards the first distal ends 123, 223, and 323 of the first, second, and third slots 12, 22, and 32 when the two of first, second, and third body structures 10, 20, and 30 pivot relative to each other from the second position to the first position. The shaft 50 moves towards the second distal ends 124, 224, and 324 of the first, second, and third slots 12, 22, and 32 when the two of first, second, and third body structures 10, 20, and 30 pivot relative to each other from the first position to the second position.

The first, second, and third body structures 10, 20, and 30 are locked and are prevented from pivoting relative to each other when the shaft 50 is restrained by the first, second, and third slots 12, 22, and 32. However, the first, second, and third body structures 10, 20, and 30 can be forced to pivot and cause the shaft 50 to become unrestrained.

The first, second, and third body structures 10, 20, and 30 include a plurality of washers 60, i.e., washers 61, 62, 63, 64, and 65 installed therebetween to reduce noise and vibration. Each of the plurality of washers has a through hole. The washers 61 and 63 are installed between the first and second body structures 10 and 20. The washers 62 and 64 are installed between the second and third body structures 20 and 30. The pivot 40 bears the washers 61, 62, and 65 by inserting through the through holes of the washers 61, 62, and 65. The shaft 50 bears the washers 63 and 64 by inserting through the through holes of the washers 63 and 64. The washers 61, 62, 63, 64, and 65 are made of rubber.

In view of the forgoing, the pair of self-locking pliers can be used to hold an object. When the pair of self-locking pliers holds the object, the object is gripped by the two jaws 13 and 33 and is disposed between the two jaws 13 and 33. The jaws 13 and 33 are prevented from moving apart from each other when the first, second, and third slots 12, 22, and 32 restrain with the shaft 50. Furthermore, when the shaft 50 is unrestrained, the first, second, and third body structures 10, 20, and 30 can pivot relative to each other again, thereby allowing the jaws 13 and 33 to move apart from each other and free the object.

Furthermore, a user can operate the pair of locking pliers without suffering vibrating noise resulting from relative pivotal movements between the first, second, and third body structures 10, 20, and 30.

The foregoing is merely illustrative of the principles of this invention and various modifications can be made by those skilled in the art without departing from the scope and spirit of the invention.

What is claimed is:

1. A pair of self-locking pliers comprising:
a first body structure having a first pivot connection and a first slot, with the first slot extending in depth through the first body structure, and with the first slot extending in length in a straight line and forming two opposite straight lateral sides;
a second body structure having a second pivot connection and a second slot, with the second slot extending in depth through the second body structure, and with the second slot extending in length in a straight line and forming two opposite straight lateral sides;
a third body structure having a third pivot connection and a third slot, with the third slot extending in depth through the third body structure, and with the third slot extending in length in a straight line and forming two opposite straight lateral sides;
a pivot pivotally connecting the first, second, and third body structures at the first, second, and third pivot connections such that the first, second, and third body structures are pivotal relative to each other and about the pivot;
a shaft connecting the first, second, and third body structures and movably disposed in the first, second, and third slots, wherein the two lateral sides of the first, second, and third slots cooperate to surround a space and the shaft is constrained in the space;
wherein two of the first, second, and third body structures include two jaws and are pivotal relative to each other between a first position in which the two jaws are disposed adjacent to each other, and a second position in which the two jaws are disposed apart from each other and; and
wherein the space is formed at a location in proximity to first distal ends of the first, second, and third slots and constrains the shaft when the two jaws are disposed adjacent to each other; and
wherein the space is formed at a location in proximity to second distal ends of the first, second, and third slots and constrains the shaft when the two jaws are disposed apart from each other; and
wherein the shaft moves towards the first distal ends of the first, second, and third slots when the two of first, second, and third body structures pivot relative to each other from the second position to the first position, wherein the shaft moves towards the second distal ends of the first, second, and third slots when the two of first, second, and third body structures pivot relative to each other from the first position to the second position, and wherein the first, second, and third slots are adapted to releasably restrain the shaft, thereby preventing the first, second, and third body structures from pivoting relative to each other.

2. The pair of self-locking pliers as claimed in claim 1, wherein the first slot extends in length along a first axis, wherein the second slot extends in length along a second axis, wherein the third slot extends in length along a third axis, wherein the first, second, and third axes intersect at a location in proximity to the first distal ends of the first, second, and third slots when the two jaws are disposed adjacent to each other, and wherein the first, second, and third axes intersect at a location in proximity to the second distal ends of the first, second, and third slots when the two jaws are disposed apart from each other.

3. The pair of self-locking pliers as claimed in claim 2, wherein two of the first, second, and third slots form a v-shaped configuration when the two jaws are disposed adjacent to each other, and form an inverted v-shaped configuration when the two jaws are disposed apart from each other.

4. The pair of self-locking pliers as claimed in claim 1, wherein the shaft is of a diametrical size and each of the first, second, and third slots is of a width larger than the diametrical size.

5. The pair of self-locking pliers as claimed in claim 4, wherein each of the first, or second, or third slots includes the width 1.001-1.2 times the diametrical size of the shaft.

6. The pair of self-locking pliers as claimed in claim 1, wherein each of the first, second, and third slots has a length, and wherein two of the first, second, and third slots are of the same length substantially and another of the first, second, and third slots is of a length shorter than those of the two of the first, second, and third slots.

7. The pair of self-locking pliers as claimed in claim 1, wherein the two of the first, second, and third body structures include two handles, wherein one of the two jaws and one of the two handles are located at opposite ends of one of the two of the first, second, and third body structures, wherein another of the two jaws and another of the two handles are located at opposite ends of another of the two of the first, second, and third body structures.

8. The pair of self-locking pliers as claimed in claim 1, wherein the first, second, and third body structures include a plurality of washers installed therebetween to reduce noise and vibration.

9. The pair of self-locking pliers as claimed in claim 8, wherein each of the plurality of washers has a through hole, wherein each of the first, second, and third pivot connections forms a through aperture, wherein the first, second, and third body structures, wherein the plurality of washers divides into first and second groups of the plurality of washers, wherein the pivot is inserted through the through holes of the first group of the plurality of washers and the first, second, third pivot connections, and wherein the shaft is inserted through the through holes of the second group of the plurality of washers and the first, second, and third slots.

10. The pair of self-locking pliers as claimed in claim 3, wherein the shaft is of a diametrical size and each of the first, second, and third slots is of a width larger than the diametrical size.

11. The pair of self-locking pliers as claimed in claim 10, wherein each of the first, or second, or third slots includes the width 1.001-1.2 times the diametrical size of the shaft.

12. The pair of self-locking pliers as claimed in claim 3, wherein the first, second, and third body structures include a plurality of washers installed therebetween to reduce noise and vibration.

13. The pair of self-locking pliers as claimed in claim 12, wherein each of the plurality of washers has a through hole, wherein each of the first, second, and third pivot connections forms a through aperture, wherein the first, second, and third body structures, wherein the plurality of washers divides into first and second groups of the plurality of washers, wherein the pivot is inserted through the through holes of the first group of the plurality of washers and the first, second, third pivot connections, and wherein the shaft is inserted through the through holes of the second group of the plurality of washers and the first, second, and third slots.

14. The pair of self-locking pliers as claimed in claim 13, wherein the shaft is of a diametrical size and each of the first, second, and third slots is of a width larger than the diametrical size.

15. The pair of self-locking pliers as claimed in claim 14, wherein each of the first, or second, or third slots includes the width 1.001-1.2 times the diametrical size of the shaft.
